(19) United States
(12) Patent Application Publication
(10) Pub. No.: US 2014/0074866 A1
(43) Pub. Date: Mar. 13, 2014

(54) SYSTEM AND METHOD FOR ENHANCING METADATA IN A VIDEO PROCESSING ENVIRONMENT

(71) Applicants: Sandipkumar V. Shah, Sunnyvale, CA (US); Ananth Sankar, Palo Alto, CA (US)

(72) Inventors: Sandipkumar V. Shah, Sunnyvale, CA (US); Ananth Sankar, Palo Alto, CA (US)

(73) Assignee: Cisco Technology, Inc., San Jose, CA (US)

(21) Appl. No.: 13/608,787

(22) Filed: Sep. 10, 2012

(51) Int. Cl. G06F 17/30

(52) U.S. Cl. 707/749; 707/736; 707/E17.028

(57) ABSTRACT

A method is provided in one example embodiment and includes detecting user interaction associated with a video file; extracting interaction information that is based on the user interaction associated with the video file; and enhancing the metadata based on the interaction information. In more particular embodiments, the enhancing can include generating additional metadata associated with the video file. Additionally, the enhancing can include determining relevance values associated with the metadata.

### TECHNICAL FIELD

This disclosure relates in general to the field of communications and, more particularly, to a system and a method for enhancing metadata in a video processing environment.

### BACKGROUND

The ability to effectively gather, associate, and organize information presents a significant obstacle for component manufacturers, system designers, and network operators. As new communication platforms and technologies become available, new protocols should be developed in order to optimize the use of these emerging protocols. With the emergence of high-bandwidth networks and devices, enterprises can optimize global collaboration through creation of videos, and personalize connections between customers, partners, employees, and students through user-generated video content. Widespread use of video and audio drives advances in technology for video processing, video creation, uploading, searching, and viewing.

### BRIEF DESCRIPTION OF THE DRAWINGS

To provide a more complete understanding of the present disclosure and features and advantages thereof, reference is made to the following description, taken in conjunction with the accompanying figures, wherein like reference numerals represent like parts, in which:

FIG. 1 is a simplified block diagram illustrating a communication system for enhancing metadata in a video processing environment according to an example embodiment;

FIG. 2 is an example screen shot in accordance with one embodiment;

FIG. 3 is a simplified block diagram illustrating details that may be associated with an example embodiment of the communication system;

FIG. 4 is a simplified block diagram illustrating other example details of the communication system in accordance with an embodiment of communication system;

FIG. 5 is a simplified block diagram illustrating yet other example details of an embodiments of communication system;

FIG. 6 is a simplified block diagram illustrating yet other example details of an embodiments of communication system;

FIG. 7 is a simplified block diagram illustrating yet other example details of an embodiments of communication system; and

FIG. 8 is a simplified flow diagram illustrating example activities that may be associated with an embodiment of the communication system.

### DETAILED DESCRIPTION OF EXAMPLE EMBODIMENTS OVERVIEW

A method is provided in one example embodiment and includes detecting user interaction associated with a video file; extracting interaction information that is based on the user interaction associated with the video file; and enhancing the metadata based on the interaction information. In this context, the term ‘enhancing’ is meant to encompass any type of modifying, changing, refining, improving, bettering, or augmenting metadata. This further includes any activity associated with increasing the accuracy, labeling, or identification of the metadata. In more particular embodiments, the enhancing can include generating additional metadata associated with the video file. Additionally, the enhancing can include determining relevance values associated with the metadata.

In more specific implementations, the determining of the relevance values can include generating a first set of relevance values of the metadata for a first group of users, and generating a second set of relevance values of the metadata for a second group of users that are different from the first group of users. The interaction information can include various types of metadata such as additional metadata generated from user clicks during viewing of the video file; additional metadata associated with reinforcement signals for the video file; and additional metadata associated with time segments of interest for the video file. A metadata model may be refined with the metadata that was enhanced in order to predict a video of interest for a particular user.

In other examples, the method can include displaying the metadata that was enhanced on an interactive portal configured to receive a search query for a particular video file. The metadata that is displayed in the interactive portal can be selected to view a corresponding video segment. In addition, the metadata that is enhanced can be displayed according to corresponding relevance values, where more relevant metadata is displayed more prominently than less relevant metadata.

### EXAMPLE EMBODIMENTS

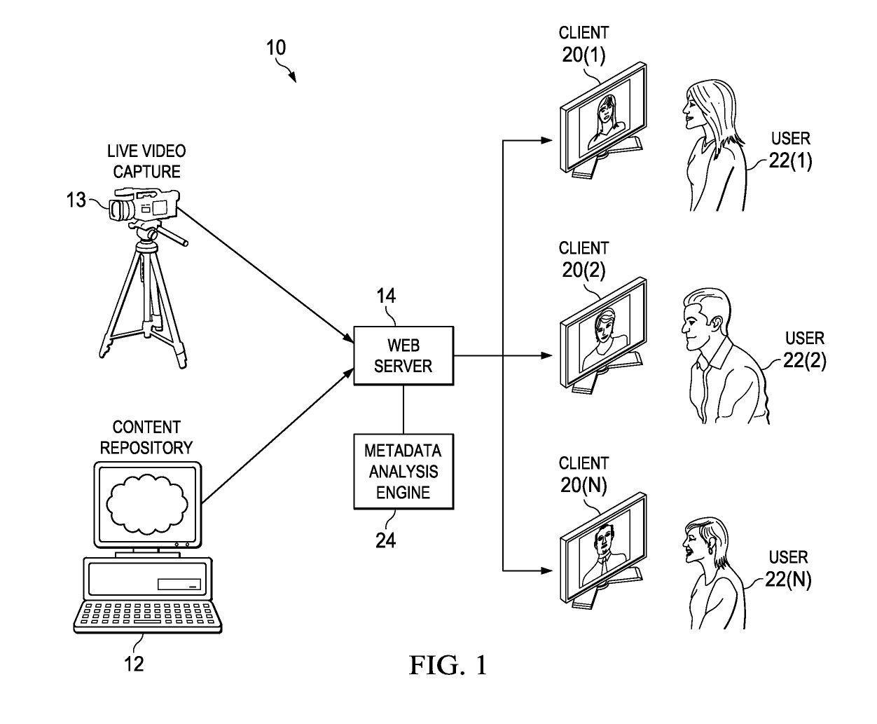

Turning to FIG. 1, FIG. 1 is a simplified block diagram illustrating a communication system 10 for enhancing metadata in a video processing environment in accordance with one example embodiment. Communication system 10 includes a content repository 12 and a live video capture 13 that can communicate videos with a web server 14. In various embodiments, web server 14 may encode the videos and stream them to multiple clients 20(1)-20(N). Users 22(1)-22(N) may consume the videos at various clients 20(1)-20(N), which are reflective of any suitable device or system for consuming data. In various embodiments, web server 14 may be provisioned with a metadata analysis engine 24 that can learn and boost metadata and, further, create new metadata based on analysis of user behavior.

In accordance with the teachings of the present disclosure, communication system 10 is configured to offer a framework for analyzing the behavior of users (e.g., who may be watching a video) to generate positive and negative feedback signals. These signals can be used to learn new metadata, enhance old metadata, and/or create user-specific metadata such that the quality of metadata (and the user experience) systematically improves over time. In essence, the architecture of communication system 10 can utilize behavior analysis to improve metadata for videos. Such activities can offer various advantages such as making videos more relevant to particular groups of users. In addition, a given user can add new metadata implicitly (e.g., in the context of popular time segments) and explicitly (e.g., in the context of user-entered key phrases). Separately, the architecture can learn different metadata for different user populations. Additionally, such a system can learn metadata based on user suggested metadata, as discussed below.

For purposes of illustrating the techniques of communication system 10, it is important to understand the communications in a given system such as the system shown in FIG. 1. The following foundational information may be viewed as a basis from which the present disclosure may be properly explained. Such information is offered earnestly for purposes of explanation only and, accordingly, should not be construed in any way to limit the broad scope of the present disclosure and its potential applications.

Video sharing applications at the enterprise level may enable creating secure video communities to share ideas and expertise, optimize global video collaboration, and personalize connection between customers, employees, and others with user-generated content. Many such applications provide the ability to create live and on-demand video content and configure who can watch specific content. The applications may also offer collaboration tools, such as commenting, rating, word tagging, and access reporting. Some applications (e.g., Cisco Show and Share) fit into an existing Internet Protocol (IP) network, and enable distribution, viewing, and sharing of video content securely within the network. Typically, such applications use metadata from the video files to enable many of their functionalities.

Metadata can be considered equivalent to a label on the video. Once metadata is created or extracted from a video file, relevant keywords and descriptions can then be selected to drive effective search engine optimization (SEO) and other applications. For example, metadata can be used by search engines to rank content in a search directory. In another example, metadata can be used to generate short descriptions of the videos in the search results and enhance the search process. Other examples include: searching at a file or scene level, creating, displaying and sharing video (or audio) clips and playlists, creating advertising insertion points and advertising logic, and generating detailed usage tracking and reporting data.

Metadata may be generated manually or automatically. In automatic generation, suitable software processes the video file and generates metadata automatically. The generation may be based on various mechanisms, such as speech to text conversion mechanisms, speaker identification, face recognition, scene identification, and keyword extraction. Machine learning mechanisms may be implemented to handle features of the video files. In a general sense, such mechanisms rely primarily on content (and embedded information) analysis to generate the metadata.

Automatic generation can also include recommendation and learning systems based on user feedback (or user behavior), where metadata from one resource is recommended to another resource. Recommender systems typically produce a list of recommendations through collaborative and/or content-based filtering. Collaborative filtering approaches model a user's past behavior (e.g., numerical ratings given to videos, or information about prior videos watched), as well as similar decisions made by other users, and subsequently use the generated metadata model to predict videos of interest to the user. For example, a movie-on-demand may be recommended to a user because many other users watched the movie, or alternatively, because the user, in the past, gave high ratings to movies with similar content. Content-based filtering approaches utilize a series of discrete characteristics of a video in order to recommend additional videos with similar properties. For example, an action thriller movie may be recommended to a user based on the “action” and “thriller” attributes of its content.

Turning to manual generation of metadata, an operator (e.g., network administrator) may generate the metadata. For example, metadata may be extracted from closed captions and other embedded information from a video or other media file. The operator can search the extracted text manually, or use automated software that searches for relevant keywords, which can be subsequently indexed for easier searching. In another example, the operator can manually type information as the video is being consumed (e.g., watched). Crowdsourcing (e.g., aggregating information from a multitude of users, or from users who are not the authors) can also be used to generate metadata. For example, user-generated tagging can be used to enhance metadata of video files; joint effort of user communities can result in massive amounts of tags that can be included in the metadata. In other examples, user comments (e.g., on blogs) can be analyzed to determine metadata (e.g., topic) of the video.

The relevance of documents, images, and videos may be determined (or boosted) from information, such as user interactions (e.g., clicks) without using metadata. Such mechanisms may not affect the metadata of the documents, images, and videos. For example, one such mechanism re-ranks search results to promote images that are likely to be clicked to the top of the ranked list. Ranking mechanisms to rank web pages, documents and other files also exist. Such ranking mechanisms rank a set of links retrieved from an index in response to a user query. Ranking (or re-ranking) may be based on reformulated queries, rather than metadata of the files being searched. Moreover, many ranking mechanisms may use static scores (rather than user interactions) to rank, and are applicable primarily to search results, rather than content within the files searched. Further, many of the existing mechanisms to generate metadata, or perform search optimization using user interactions, cannot be used to search and navigate content within an individual video file.

Typically, the metadata is generated once when the video is ingested or uploaded (e.g., onto content repository 12). Thereafter, the metadata may be static and fixed for all users. Some of the manually or automatically generated metadata may be tailored to a specific audience, and may not be relevant to a general audience; similarly, much of the manually or automatically generated metadata may not be relevant for specific users, although the metadata has general usability.

Communication system 10 is configured to address these issues (and others) in offering a system and a method for enhancing metadata in a video processing environment. Embodiments of communication system 10 can analyze user behavior to generate positive and negative feedback signals, which can be used to learn new metadata, boost old metadata, and also create user-specific metadata so that the quality of metadata and the user experience may improve over time, among other uses.

Metadata analysis engine 24 may detect user interaction with videos and metadata thereof, extract interaction information from the user interaction, and enhance the metadata based on the interaction information. In various embodiments, enhancing the metadata includes increasing information conveyed by the metadata. As used herein, the broad terminology “interaction information” can include any user entered metadata (e.g., typed, spoken, etc.), any reinforcement signals for metadata (e.g., positive, negative or other feedback signals obtained from user interaction, such as clicking some keywords more than others, clicking away from a video segment displayed in response to clicking on a keyword, clicking a video segment and watching it for a long time), any data associated with time segments of interest (e.g., time segments corresponding to video segments viewed more often than other video segments, time segments corresponding to undistracted viewing, etc.), any metadata extracted from user comments, and any such other information extracted from user interactions with the video and metadata.

In a specific embodiment, the metadata may be enhanced based on relevance values of metadata generated from the interaction information. As used herein, the term “relevance value” of a specific metadata encompasses a numerical, alphanumeric, or alphabetical value obtained from statistical and other analysis of the specific metadata indicating the relevance of the specific metadata to a subset of users 22(1)-22(N). In some embodiments, the relevance value of the specific metadata may be applicable to substantially all users 22(1)-22(N). In other embodiments, the relevance value of the specific metadata may be applicable to a portion of users 22(1)-22(N). For example, if set U denotes substantially all users 22(1)-22(N), the relevance values may be applicable to a subset A of users, where A⊂U. In yet other embodiments, the relevance value of the specific metadata may be applicable to a single user (e.g., user 22(1)). Relevance values may change with the metadata under analysis and the applicable subset of users. For example, the same user may have different relevance values for different metadata, and the same metadata may have different relevance values for different users. Metadata models (such as speaker recognition models, lists of key-phrases, etc.) that incorporate relevance values may be stored in a metadata model database. As used herein, the term “metadata model” may include any syntax, structure, vocabulary, element set, properties (e.g., number of clicks on keywords, etc.) of the metadata, and other standard or non-standard schemes for representing metadata in a computer readable form.

In various embodiments, the video (along with its metadata) may be presented (e.g., displayed) to the user in an interactive portal. The interactive portal may include a metadata display portion. The user (e.g., user 22(1)) can click different metadata on the interactive portal to watch different segments of the video (or hear different segments of the audio). For example, a click on a keyword can display a corresponding video segment containing the keyword. The interactive portal may also allow user 22(1) to enter additional metadata. Embodiments of communication system 10 can allow multiple users 22(1)-22(N) to watch the same video at the same or different times. The user interaction (clicks, entered metadata, duration of watching segments, etc.) recorded during viewing of the video may be collected and analyzed. In various embodiments, the analysis may generate interaction information (e.g., positive and negative reinforcement signals, the most popular time segments of the video, the user-entered metadata, etc.), which can be used to generate relevance values and refined metadata models.

Certain terminologies are used to reference the various embodiments of communication system 10. As used herein, the term “metadata” encompasses any structured and/or unstructured information that describes, identifies, explains, locates, or otherwise makes it easier to associate, retrieve, use, or manage an information resource, such as a video file or an audio file. Metadata may include data used for descriptions of video, and can include attributes and structure of videos, video content, and relationships that exist within the video, among videos and between videos and real world objects. For example, metadata of a video file may include keywords (including words, and phrases) spoken in the video, speaker identities, topics being discussed, transcripts of conversations, text descriptions of scenes, time logs of events occurring in the video, number of views, duration of views, and such other informative content. Metadata can be embedded in the corresponding video files, or it can be stored separately.

The term “client” is inclusive of applications, devices, and systems that access a service made available by a server (e.g., streaming server 18). Clients and servers may be installed on a common computer, or they may be separated over networks, including public networks, such as the Internet. In some embodiments, clients and servers may be located on a common device. According to various embodiments, clients 20(1)-20(N) may be configured (e.g., with appropriate software and hardware) to display videos in a suitable format. For example, videos can be displayed at clients 20(1)-20(N) on a Cisco® Show and Share portal. Moreover, clients 20(1)-20(N) may be configured with suitable sensors and other peripheral equipment to enable detecting user interactions of users 24(1)-24(N). “User interactions” can include user actions, including mouse clicks, keyboard entries, joystick movements, and even inactivity.

For ease of illustration (and not as any limitation), consider an example involving the framework of communication system 10 processing a particular video. Assume that a company executive named Michael records a presentation, at which he speaks about quarterly financial results, new orders, trends, and future guidelines. In between these segments, he speaks about competition as well. Once the video is recorded, manual and automatic metadata associated with video could possibly be <speaker=Michael> <keyword_start_time=10, keyword_end_time=11, keyword=“quarterly guidance”> <keyword_start_time=23, keyword_end_time=25, keyword=“sales forecast model”>, <keyword_start_time=31, keyword_end_time=32, keyword=“product roadmap,”> etc. Many users may click the “quarterly guidance” keyword and watch the video for several seconds after that. Most users may never click the “product roadmap” phrase. As a result, the metadata model may increase the relevance for “quarterly guidance” and decrease the relevance for “product roadmap.”

A specific user may add “quarter-to-quarter growth” as a key-phrase, which may be added by metadata analysis engine 24 to the metadata model database for future consideration by embodiments of communication system 10. A majority of users may watch a specific segment from 15 seconds to 60 seconds. This particular segment may be recorded into the metadata model database for future consideration. Metadata analysis engine 24 may also run automatic metadata generation on this particular segment, generating more metadata for the segment than it initially did. The quality of metadata can improve over time as more user interaction is recorded.

Embodiments of communication system 10 can analyze the behavior of users 22(1)-22(N), who are watching the videos, for example, to generate positive and negative feedback signals. The positive and negative feedback signals may be used, among other applications, to learn new metadata, boost old metadata, and also create user-specific metadata. In an example embodiment, the metadata may be improved through analysis of user behavior of a particular user (e.g., user 22(1)), making it particularly more relevant to user 22(1). User 22(1) can add new metadata implicitly (e.g., popular time segments) and explicitly (e.g., user-entered keywords). In another example embodiment, communication system 10 can learn different metadata for different user populations. The metadata may be improved through analysis of user behavior of a group of users (e.g., users 22(1)-22(M)), making it particularly more relevant to the group of users. Embodiments of communication system 10 can also learn metadata based on user-suggested metadata.

The relevance of the metadata for a video can change over time. In one example, when a video is watched multiple times (e.g., by multiple users 22(1)-22(N), or by the same user several times), and some metadata may be clicked on and the corresponding video segment watched, the clicked-on metadata may increase in relevance. In another example, if many of users 22(1)-22(N) click on a keyword corresponding to a specific video segment, and immediately move to another video segment, the keyword may decrease in relevance. In yet another example, if many users watch the same video segment multiple times, communication system 10 may tag the video segment as a time segment of interest, and suggest it to other users.

Embodiments of communication system 10 can improve the quality and effectiveness of the metadata used to index videos and to navigate within the videos. Embodiments of communication system 10 can use information from user interactions to boost the relevance and quality of automatically or manually generated metadata. By making the metadata more relevant, communication system 10 can improve the user experience for searching and consuming videos.

In one example application, metadata may be created based on popular time segments watched by users 22(1)-22(N). Metadata may also be created from user-generated metadata, for example, when a user enters tags (e.g., keywords) for the video. Embodiments of communication system 10 can be used to boost such metadata, in addition to automatically generated metadata. Embodiments of communication system 10 can learn population-specific metadata. For example, disparate business units in a company may be interested in different metadata, and embodiments of communication system 10 can identify and display different metadata of interest to different user groups.

Embodiments of communication system 10 can use user feedback to boost metadata in the videos so as to make that metadata more useful for searching and watching the videos. User feedback may be determined from user interactions with the video and corresponding metadata. User feedback may be used to improve metadata in videos, and to determine the relevance of metadata in videos. For example, if a large percentage of users 22(1)-22(N) responded in a similar way to a specific stimulus (e.g., associating a video segment with a specific keyword), then it will likely be true for most other users 22(1)-22(N), making the learning statistically valid. Other behavioral indicators, such as adjusting volume, and resizing the video display may also be used to improve metadata of the video.

Turning to the infrastructure of communication system 10, the network topology can include any number of servers, routers, gateways, and other nodes inter-connected to form a large and complex network. A node may be any electronic device, client, server, peer, service, application, or other object capable of sending, receiving, or forwarding information over communications channels in a network. Elements of FIG. 1 may be coupled to one another through one or more interfaces employing any suitable connection (wired or wireless), which provides a viable pathway for electronic communications. Additionally, any one or more of these elements may be combined or removed from the architecture based on particular configuration needs. Communication system 10 may include a configuration capable of TCP/IP communications for the electronic transmission or reception of data packets in a network. Communication system 10 may also operate in conjunction with a User Datagram Protocol/Internet Protocol (UDP/IP) or any other suitable protocol, where appropriate and based on particular needs. In addition, gateways, routers, switches, and any other suitable nodes (physical or virtual) may be used to facilitate electronic communication between various nodes in the network.

Note that the numerical and letter designations assigned to the elements of FIG. 1 do not connote any type of hierarchy; the designations are arbitrary and have been used for purposes of teaching only. Such designations should not be construed in any way to limit their capabilities, functionalities, or applications in the potential environments that may benefit from the features of communication system 10. It should be understood that the communication system 10 shown in FIG. 1 is simplified for ease of illustration.

The example network environment may be configured over a physical infrastructure that may include one or more networks and, further, may be configured in any form including, but not limited to, local area networks (LANs), wireless local area networks (WLANs), virtual local area networks (VLANs), metropolitan area networks (MANs), wide area networks (WANs), virtual private networks (VPNs), Intranet, Extranet, any other appropriate architecture or system, or any combination thereof that facilitates communications in a network. In some embodiments, a communication link may represent any electronic link supporting a LAN environment such as, for example, cable, Ethernet, wireless technologies (e.g., IEEE 802.11x), ATM, fiber optics, etc. or any suitable combination thereof. In other embodiments, communication links may represent a remote connection through any appropriate medium (e.g., digital subscriber lines (DSL), telephone lines, T1 lines, T3 lines, wireless, satellite, fiber optics, cable, Ethernet, etc. or any combination thereof) and/or through any additional networks such as a wide area networks (e.g., the Internet).

In particular embodiments, content repository 12 may store video and other media files. Substantially all video-on-demand streaming requests may be serviced from content repository 12. Content repository 12 may include web server 14 as a front-end. Web server 14 can be any web server such as Internet Information Services (IIS) on Windows-based servers and Apache on Linux-based servers. In various embodiments, web server 14 may include a digital media encoder that can capture and digitize digital media from a variety of digital formats for live and on-demand delivery. The digital media encoder may be locally managed, or remotely managed, with appropriate manager applications. For example, the digital media encoder may be provisioned with (or communicate with) a manager application that allows content authors to publish rich digital media through a web-based management application. The manager application may manage the digital media encoder directly from an appropriate web interface accessible to a network administrator. Content offerings, both live and on-demand, can be managed in a suitable program manager module on an appropriate interface. Different content offerings can be displayed and featured, for example, in a ‘Featured Playlist.’ Moreover, interactive portal viewer selection activity may be stored and made available for detailed usage reporting. The report can provide details about user interactions of users 22(1)-22(N) with the metadata and video, and a variety of other usage reports.

In various embodiments, web server 14 may include general server functionalities (e.g., ability to respond to client requests), and appropriate software to enable providing streaming media files in various formats according to particular needs (e.g., as in a streaming server). Web server 14 may acquire live content (created by live video capture 13) through a pull mechanism. On-demand videos may be stored in content repository 12, for example, in a video-on-demand directory.

In many embodiments, clients 20(1)-20(N) may be configured with appropriate applications that provide viewer collaboration tools such as commenting, rating, and word tagging, and access reporting. In some embodiments, the appropriate applications may communicate with web server 14 to transcode video files, for example, to window sized and bit rate using MPEG-4/H.264 format. The appropriate applications may enable browsing videos, searching videos, viewing and rating videos, sharing videos, commenting on videos, recording videos, uploading and publishing videos, among other features. Content offerings may be organized into categories (e.g., custom categories) that represent common content characteristics such as topic, subject matter or course offering, target audience, featured executive, and business function.

In various embodiments, communication system 10 can include other features and network elements not illustrated in FIG. 1. For example, when one of clients 20(1)-20(N) requests a video, a local Wide Area Application Engine (WAE) may act as a proxy by intercepting the request for the information and the video (including live feed or on demand video) from streaming server 16 through whichever proxy settings are configured on the network. The video stream may be delivered directly to respective one of clients 20(1)-20(N) by the local WAE.

Users 22(1)-22(N) can have various roles and responsibilities, with correspondingly different levels of access and permissions. User accounts for users 22(1)-22(N) may be created with corresponding passwords, permissions, and profiles. User identities may be obtained through corresponding login credentials, and matched to user profiles. In one example, the user profiles may specify access permissions for certain video categories, content, keywords, etc.

In various embodiments, metadata analysis engine 24 is an application provisioned in (or accessible by) web server 14. In one embodiment, metadata analysis engine 24 may be provisioned in web server 14 as an embedded application. In another embodiment, metadata analysis engine 24 may be coupled to the manager application, and accessed by (or accessible by) web server 14. In yet another embodiment, metadata analysis engine 24 may be a stand-alone application that can access web server 14.

Although the example embodiment illustrated in FIG. 1 describes a network environment, embodiments of communication system 10 may be implemented in other video processing environments also. For example, metadata analysis engine 24 may be included in content repository 12, which may be directly coupled to client 20(1) on a single device (e.g., desktop computer). In another example, a video camcorder may be provisioned with live video capture 13, content repository 12 (e.g., in the form of a disk tape), metadata analysis engine 24 (e.g., as an application implemented on a hard drive of the video camcorder), and client 20(1) (e.g., as a display screen on the video camcorder).

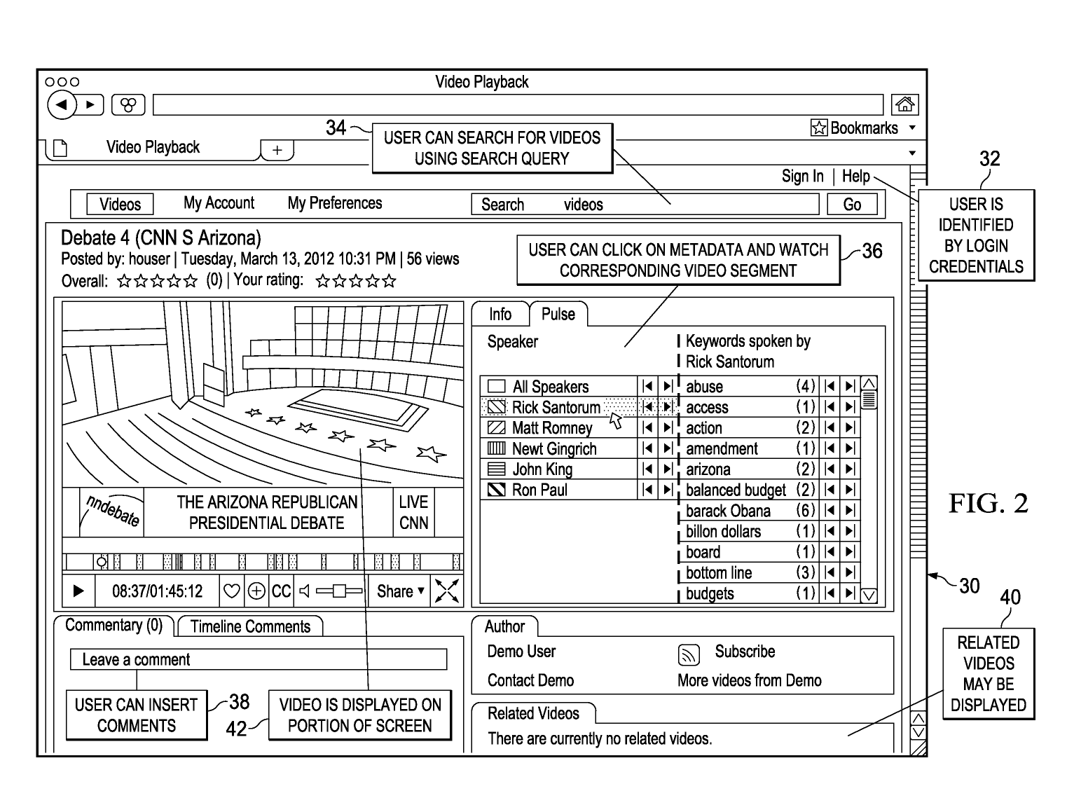

Turning to FIG. 2, FIG. 2 is a simplified representation of an example screen shot of an interactive portal 30 according to an embodiment of communication system 10. Interactive portal 30 may allow a representative user 22 to conveniently and quickly browse, search, and view content interactively. In some embodiments, browsing may be configured based on the user's profile obtained through user 22's login credentials. User 22 may be identified by login credentials through login link 32. In example interactive portal 30, videos can be located by content category, title, keyword, or other metadata by typing the search query in a search field 34. User 22 can type in words or phrases to search for video files and access advanced search options (e.g., filters) to further refine content searches. For example, user 22 can sort through categories by different filters and views, such as “Most Viewed” and “Highest Rated” content filters.

User 22 can use metadata such as keywords and speaker identities displayed in portion 36, to navigate content within a video. For example, user 22 can click on a keyword and watch the corresponding video segment. In various embodiments, the video may contain multiple keywords, and each keyword may occur multiple times in the video. Keywords may be tagged automatically according to their respective location in the video. User 22 can search or go to the specific section of the video where the keyword was spoken by clicking on the keyword. Metadata may also include speaker identities. The video may have multiple speakers. Each speaker may speak multiple times at different time intervals in the video. Corresponding speaker segments may be identified in the video. User 22 can search or go to the specific section of the video featuring a particular speaker by clicking on the speaker name in the metadata list.

In example embodiments, user 22 can comment on the video in a comment field 38. Page comments can be created for general commentary and timeline comments can be placed at any point in the video timeline for topical discussions. The comments may be incorporated in the metadata of the video. Supplemental information, such as tickers, further reading, Web sites, and downloadable materials may also be displayed on interactive portal 30. For example, related videos (e.g., related to the search query, or related according to content, or other metadata) may be displayed in a related videos portion 40. The video identified in the search query and selected for viewing by user 22 may be displayed in a video display portion 42.

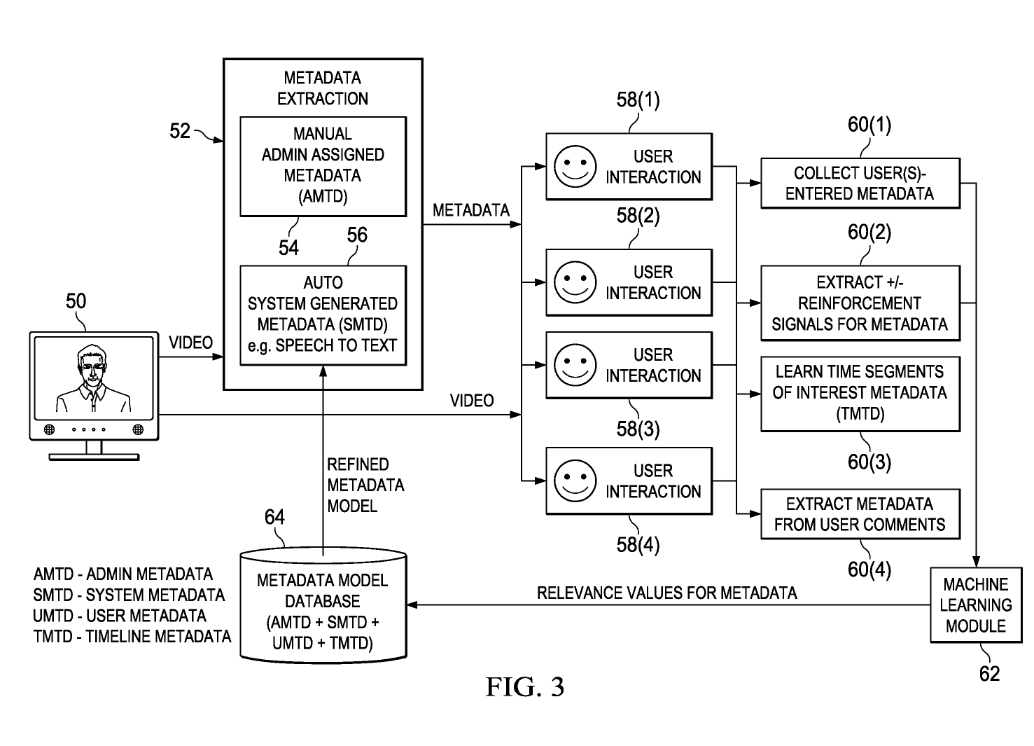

Turning to FIG. 3, FIG. 3 is a simplified flow diagram indicating example operations that may be associated with embodiments of communication system 10. Video 50 may be processed according to metadata extraction 52. Metadata extraction 52 may extract at least two types of metadata: (1) administrator (“admin”) assigned metadata (AMTD) 54, and system generated metadata (SMTD) 56. AMTD 54 may be manually generated metadata, in contrast to SMTD 56, which may be automatically generated metadata.

Metadata extracted by metadata extraction 52 may be further analyzed with user interaction 58(1)-58(4). User interaction 58(1) may include user-entered metadata (e.g., user types in metadata into appropriate field in GUI). User entered metadata may be collected at 60(1). User interaction 58(2) may include positive and negative reinforcement signals for metadata. For example, a keyword may be clicked and a corresponding video segment watched multiple times, signaling a positive reinforcement for the keyword. In another example, a keyword may be less frequently clicked by any user, signaling a negative reinforcement for the keyword. In another example, several users may click a keyword and immediately watch the corresponding video segment for several seconds, indicating that the keyword was relevant, resulting in a positive reinforcement signal. If several users click a keyword and immediately click some other keyword, the clicking away action may indicate that the keyword was not relevant to the displayed video segment (and vice versa), resulting in a negative reinforcement signal for that keyword for that video segment. The positive and negative reinforcement signals may be extracted at 60(2).

User interaction 58(3) may include time segments of interest metadata (TMTD). For example, a particular segment may be watched multiple times, indicating a higher interest in the video segment. TMTD may be learnt at 60(3). Various other user interaction and corresponding collection, extraction, and learning, among other operations, may be implemented within the broad scope of the present disclosure. User interaction 58(4) may include user-entered comments. For example, the user may type in comments on the portal where the video is being viewed. The comments may have particular relevance to the video segment currently playing on the portal. Metadata from the user comments may be extracted at 60(4). The metadata may include keywords in the comments, time segment relevant to the comments, and other information, such as user identity.

In various embodiments, the positive and negative reinforcement signals, user entered metadata, TMTD, and metadata extracted from user comments, among other features, may be fed to a machine learning module 62 in metadata analysis engine 24 along with the corresponding metadata. Machine learning module 62 may learn the relevance of metadata over time, boosting the “good” metadata (e.g., metadata, for which user behavior indicated a positive reinforcement, metadata with high relevance value), and de-weighting the “bad” metadata (e.g., metadata, for which user behavior indicated a negative reinforcement, metadata with low relevance value). The output from machine learning module 62 may be fed to a metadata model database 64. Metadata model database 64 may include models for AMTD, SMTD, user metadata (UMTD) and TMTD. In some embodiments, most popular time segments watched by users 22(1)-22(N), and user-entered metadata may also be used by machine learning module 62 to create metadata models. In some embodiments, metadata can be fine-tuned for specific user populations based on analyzing the user interactions in those populations. The user feedback mechanism may thus be used to improve metadata substantially continually, leading to enhanced metadata quality over time.

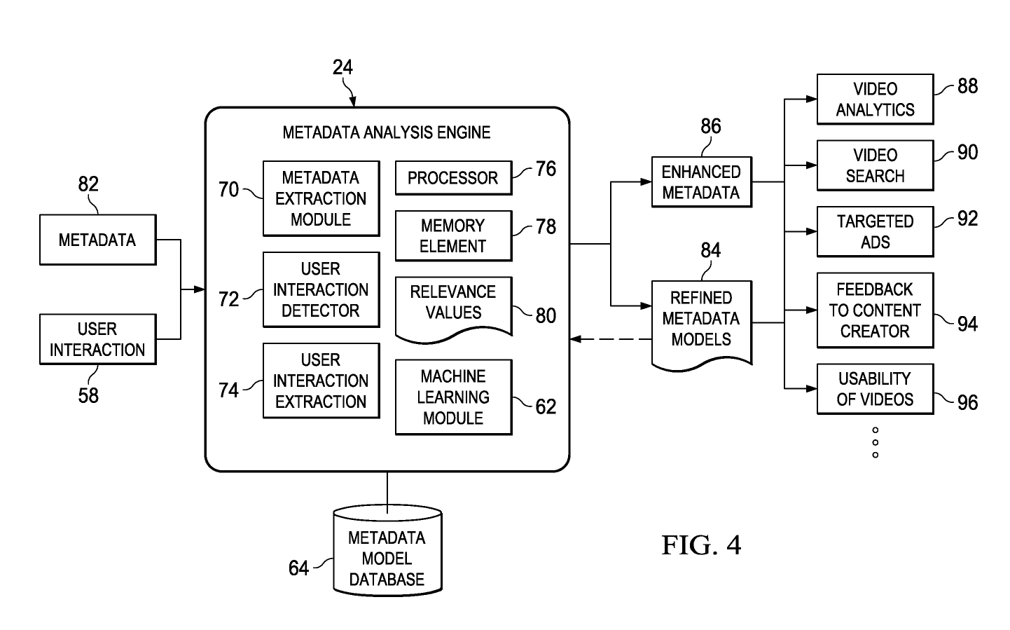

Turning to FIG. 4, FIG. 4 is a simplified block diagram illustrating details of an example embodiment of communication system 10. Metadata analysis engine 24 may include a metadata extraction module 70, a user interaction detector 72, a user interaction extractor 74, machine learning module 62, a processor 76, a memory element 78, and relevance values 80. Metadata analysis engine 24 may use metadata 82 (e.g., AMTD 54, SMTD 56), user interaction 58, and/or access metadata model database 64, to generate refined metadata models 84 and enhanced metadata 86.

In various embodiments, metadata extraction module 70 may identify metadata 82 associated with video 50. User interaction detector 72 may detect user interaction 58. Examples of user interaction detector 72 may include keyboard, mouse, camera, and other sensors, and corresponding detectors that receive signals from such devices. User interaction extractor 74 may extract interaction information from user interaction detector 72. For example, user interaction 58 may include a mouse click. User interaction detector 72 may indicate that the mouse was clicked. User interaction extractor 74 may determine that the user clicked on a specific keyword. Machine learning module 62 may use input from user interaction extractor 74 to generate relevance values 80 for metadata 82, including the clicked keyword.

In some embodiments, relevance values 80 may be fed to metadata model database 64, and refined metadata models 84 may be generated. In another embodiment, machine learning module 62 may generate refined metadata models 84 from a subset of metadata 84, such as most popular time segments watched by users 22(1)-22(N) (or a portion thereof), and user-entered metadata. Refined metadata models 84 may be fed to metadata extraction module 70 and further refinements may be calculated, as needed. In some embodiments, refined metadata models 84 may include enhanced metadata 86. Metadata analysis engine 24 may use processor 76 and memory element 78 to perform various operations as described herein.

In various embodiments, enhanced metadata 86 may represent improvements to metadata 82 based on user interaction 58. User interaction 58 may indicate user feedback (e.g., whether particular metadata is relevant or not relevant) of metadata and the corresponding video. Enhanced metadata 86 can be used for myriad applications, such as video analytics 88; video search 90; targeted ads 92; feedback to content generator 94; usability of videos 96; and various other applications. For example, enhanced metadata 86 may be used to improve video analytics 88, and get more information from the video content. Video search 90 may be improved from using additional information conveyed by enhanced metadata 86 as compared to metadata 82. Improved targeted ads 92 may be generated from enhanced metadata 86 as compared to metadata 82. For example, when specific users (e.g., users 22(1), 22(2)) click a particular keyword more than other keywords, ads including the particular keyword may be targeted at specific users (e.g., users 22(1), 22(2)). User interaction 58 may be indicated by information conveyed by enhanced metadata 86, thereby providing valuable feedback to content creators.

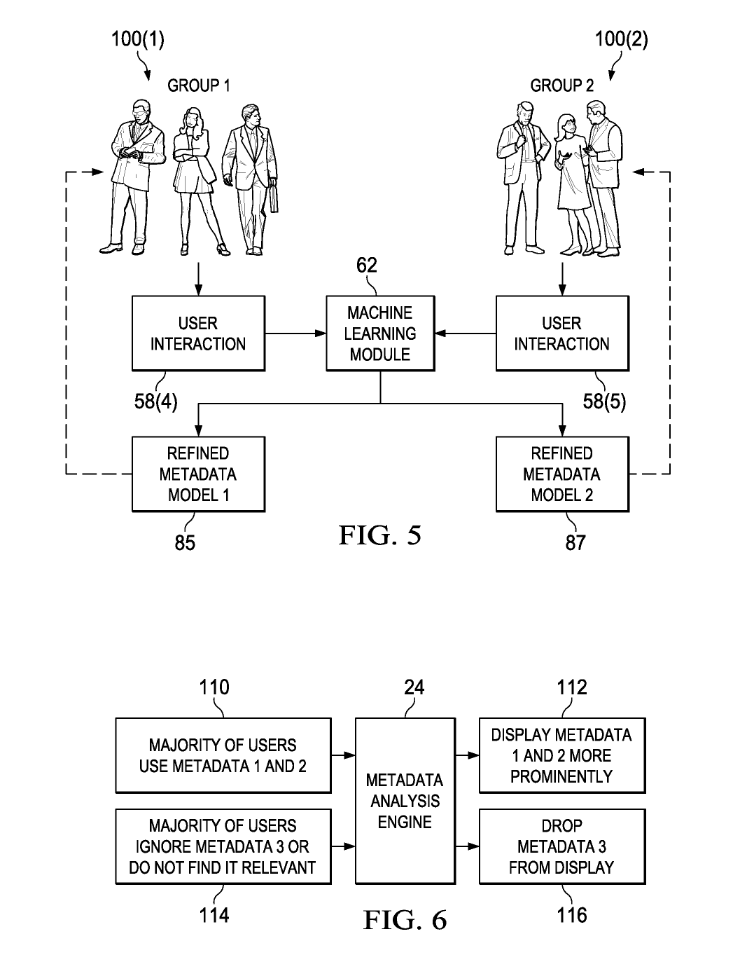

Turning to FIG. 5, FIG. 5 is a simplified block diagram indicating example details of an embodiment of communication system 10. Users 100(1) in group 1 may generate user interaction 58(4). Users 100(2) in group 2 may generate user interaction 58(5). Machine learning module 62 may generate refined metadata model 1, indicated by 80(1), based on user interaction 58(4). Machine learning module 62 may generate refined metadata model 2, indicated by 80(2), based on user interaction 58(5). Refined metadata models 84(1) may be applicable to users 100(1) in group 1; refined metadata models 84(2) may be applicable to users 100(2) in group 2. For example, user interaction 58(4) may indicate that users 100(1) click keywords k1, k2, k3 out of a set {k1, k2, k3, k4, k5}. User interaction 58(5) may indicate that users 100(2) click keywords k3, k4 and k5 out of set {k1, k2, k3, k4, k5}. Refined metadata models 84(1) may indicate that keywords k1, k2 and k3 are more relevant to users 100(1) than to users 100(2); whereas keywords k3, k4, and k5 are more relevant to users 100(2) than to users 100(1).

Such information may be useful in many scenarios. For example, advertisements relevant to keywords k1, k2 and k3 may be targeted to users 100(1), rather than to users 100(2); similarly, advertisements relevant to keywords k3, k4 and k5 may be targeted to users 100(2) rather than to users 100(1). Video analytics may extract different information from videos watched by users 100(1) compared to the same videos watched by users 100(2), based, for example, on differences between refined metadata models 84(1) and 80(2). Various other uses can be implemented within the broad scope of the present disclosure.

Turning to FIG. 6, FIG. 6 is a simplified block diagram showing example operations that may be associated with embodiments of communication system 10. At 110, a majority of users 22(1)-22(N) may use metadata 1 and 2 more than other metadata. Metadata analysis engine 24 may display metadata 1 and 2 more prominently than other metadata at 112. For example, metadata 1 and 2 may be displayed in bold, or presented first in a list of other metadata, or displayed in a manner more visible to the user on the applicable user interface (e.g., interactive portal 30). In another example operation, at 114, a majority of users 22(1)-22(N) may ignore metadata 3 or not find it relevant. Metadata analysis engine 24 may drop metadata 3 from display (e.g., on interactive portal 30) at 116.

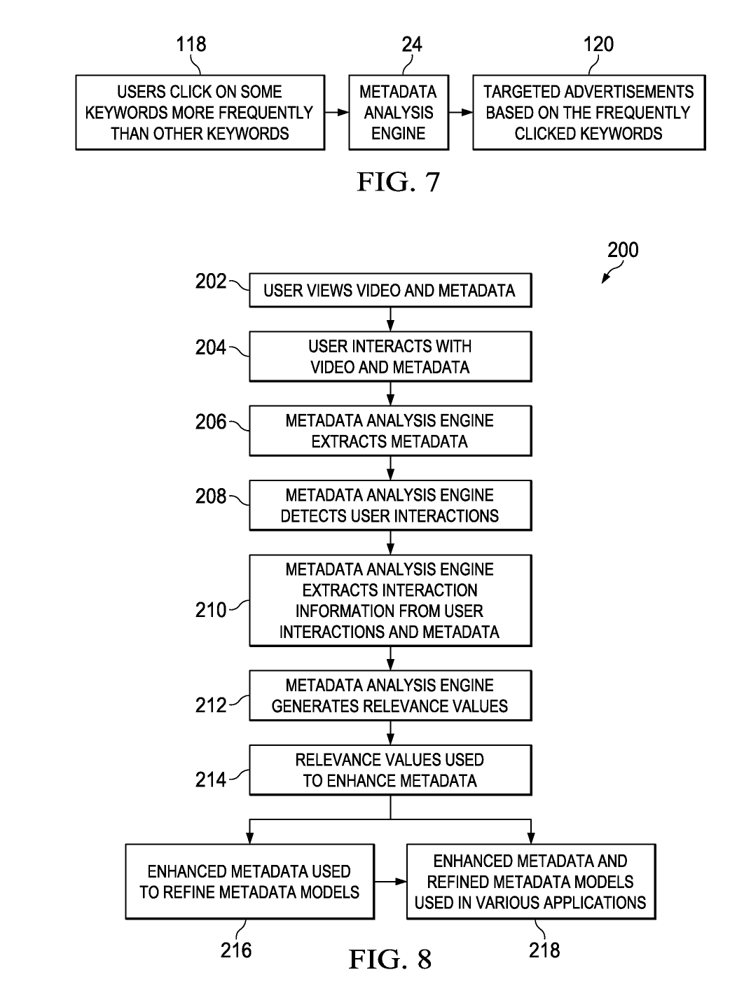

Turning to FIG. 7, FIG. 7 is a simplified block diagram showing other example operations that may be associated with embodiments of communication system 10. At 118, user 22(1)-22(N) may click on some keywords more frequently than other keywords. Metadata analysis engine 24 may include information related to the frequently clicked keywords in enhanced metadata 86 sent to targeted ads 92. At 120, targeted advertisements based on the frequently clicked keywords may be displayed to users 22(1)-22(N).

Turning to FIG. 8, FIG. 8 is a simplified flow diagram illustrating example operational activities associated with generating enhanced metadata 86. At 202, one of users 22(1)-22(N), say user 22(1), views video 50 and metadata 82 on interactive portal 30. At 204, user 22(1) interacts with video 50 and metadata 82 through user interaction 58. At 206, metadata analysis engine 24 may extract metadata 82. At 208, metadata analysis engine 24 may detect user interaction 58. At 210, metadata analysis engine 24 may extract interaction information from user interaction 58 and metadata 82.

At 212, metadata analysis engine 24 may generate relevance values 80. In some embodiments, relevance values 80 may be generated for each metadata 82. In other embodiments, relevance values 80 may be generated for each metadata 82, as applied to the user (or relevant user group). At 214, relevance values 80 may be used to enhance metadata 82 and generate enhanced metadata 86. For example, relevance values 80 may decrease relevance of some keywords in comparison to others, enhancing information conveyed by metadata 82. At 216, enhanced metadata 86 may be used to refine metadata models and generate refined metadata models 84. At 218, enhanced metadata 86 and refined metadata models 84 may be used in various applications (e.g., video analytics, video search, targeted ads, etc.).

Note that in this Specification, references to various features (e.g., elements, structures, modules, components, steps, operations, characteristics, etc.) included in “one embodiment”, “example embodiment”, “an embodiment”, “another embodiment”, “some embodiments”, “various embodiments”, “other embodiments”, “alternative embodiment”, and the like are intended to mean that any such features are included in one or more embodiments of the present disclosure, but may or may not necessarily be combined in the same embodiments. Note also that an “application” as used herein this Specification, can be inclusive of an executable file comprising instructions that can be understood and processed on a computer, and may further include library modules loaded during execution, object files, system files, hardware logic, software logic, or any other executable modules.

In example implementations, at least some portions of the activities outlined herein may be implemented in software in, for example, metadata analysis engine 24. In some embodiments, one or more of these features may be implemented in hardware, provided external to these elements, or consolidated in any appropriate manner to achieve the intended functionality. The various network elements may include software (or reciprocating software) that can coordinate in order to achieve the operations as outlined herein. In still other embodiments, these elements may include any suitable algorithms, hardware, software, components, modules, interfaces, or objects that facilitate the operations thereof.

Furthermore, metadata analysis engine 24 described and shown herein (and/or its associated structures) may also include suitable interfaces for receiving, transmitting, and/or otherwise communicating data or information in a network environment. Additionally, some of the processors and memory elements associated with the various nodes may be removed, or otherwise consolidated such that a single processor and a single memory element are responsible for certain activities. In a general sense, the arrangements depicted in the FIGURES may be more logical in their representations, whereas a physical architecture may include various permutations, combinations, and/or hybrids of these elements. It is imperative to note that countless possible design configurations can be used to achieve the operational objectives outlined here. Accordingly, the associated infrastructure has a myriad of substitute arrangements, design choices, device possibilities, hardware configurations, software implementations, equipment options, etc.

In some of example embodiments, one or more memory elements (e.g., memory element 78) can store data used for the operations described herein. This includes the memory element being able to store instructions (e.g., software, logic, code, etc.) in non-transitory media such that the instructions are executed to carry out the activities described in this Specification. A processor can execute any type of instructions associated with the data to achieve the operations detailed herein in this Specification. In one example, processors (e.g., processor 76) could transform an element or an article (e.g., data) from one state or thing to another state or thing. In another example, the activities outlined herein may be implemented with fixed logic or programmable logic (e.g., software/computer instructions executed by a processor) and the elements identified herein could be some type of a programmable processor, programmable digital logic (e.g., a field programmable gate array (FPGA), an erasable programmable read only memory (EPROM), an electrically erasable programmable read only memory (EEPROM)), an ASIC that includes digital logic, software, code, electronic instructions, flash memory, optical disks, CD-ROMs, DVD ROMs, magnetic or optical cards, other types of machine-readable mediums suitable for storing electronic instructions, or any suitable combination thereof.

In operation, components in communication system 10 can include one or more memory elements (e.g., memory element 78) for storing information to be used in achieving operations as outlined herein. These devices may further keep information in any suitable type of non-transitory storage medium (e.g., random access memory (RAM), read only memory (ROM), field programmable gate array (FPGA), erasable programmable read only memory (EPROM), electrically erasable programmable ROM (EEPROM), etc.), software, hardware, or in any other suitable component, device, element, or object where appropriate and based on particular needs. The information being tracked, sent, received, or stored in communication system 10 could be provided in any database, register, table, cache, queue, control list, or storage structure, based on particular needs and implementations, all of which could be referenced in any suitable timeframe. Any of the memory items discussed herein should be construed as being encompassed within the broad term ‘memory element.’ Similarly, any of the potential processing elements, modules, and machines described in this Specification should be construed as being encompassed within the broad term ‘processor.’

It is also important to note that the operations and steps described with reference to the preceding FIGURES illustrate only some of the possible scenarios that may be executed by, or within, the system. Some of these operations may be deleted or removed where appropriate, or these steps may be modified or changed considerably without departing from the scope of the discussed concepts. In addition, the timing of these operations may be altered considerably and still achieve the results taught in this disclosure. The preceding operational flows have been offered for purposes of example and discussion. Substantial flexibility is provided by the system in that any suitable arrangements, chronologies, configurations, and timing mechanisms may be provided without departing from the teachings of the discussed concepts.

Although the present disclosure has been described in detail with reference to particular arrangements and configurations, these example configurations and arrangements may be changed significantly without departing from the scope of the present disclosure. For example, although the present disclosure has been described with reference to particular communication exchanges involving certain network access and protocols, communication system 10 may be applicable to other exchanges or routing protocols. Moreover, although communication system 10 has been illustrated with reference to particular elements and operations that facilitate the communication process, these elements, and operations may be replaced by any suitable architecture or process that achieves the intended functionality of communication system 10.

Numerous other changes, substitutions, variations, alterations, and modifications may be ascertained to one skilled in the art and it is intended that the present disclosure encompass all such changes, substitutions, variations, alterations, and modifications as falling within the scope of the appended claims. In order to assist the United States Patent and Trademark Office (USPTO) and, additionally, any readers of any patent issued on this application in interpreting the claims appended hereto, Applicant wishes to note that the Applicant: (a) does not intend any of the appended claims to invoke paragraph six (6) of 35 U.S.C. section 112 as it exists on the date of the filing hereof unless the words “means for” or “step for” are specifically used in the particular claims; and (b) does not intend, by any statement in the specification, to limit this disclosure in any way that is not otherwise reflected in the appended claims.

What is claimed is:

1. A method, comprising:
detecting user interaction associated with a video file;
extracting interaction information that is based on the user interaction associated with the video file; and
enhancing the metadata based on the interaction information.

2. The method of claim 1, wherein the enhancing comprises generating additional metadata associated with the video file.

3. The method of claim 1, wherein the enhancing comprises determining relevance values associated with the metadata.

4. The method of claim 3, wherein the determining of the relevance values comprises generating a first set of relevance values of the metadata for a first group of users, and generating a second set of relevance values of the metadata for a second group of users that are different from the first group of users.

5. The method of claim 1, wherein the interaction information comprises a selected one of a group of metadata, the group consisting of:
(a) additional metadata generated from user clicks during viewing of the video file;
(b) additional metadata associated with reinforcement signals for the video file; and
(c) additional metadata associated with time segments of interest for the video file.

6. The method of claim 1, further comprising:
refining a metadata model with the metadata that was enhanced in order to predict a video of interest for a particular user.

7. The method of claim 1, further comprising:
displaying the metadata that was enhanced on an interactive portal configured to receive a search query for a particular video file.

8. The method of claim 7, wherein the interactive portal further includes one or more of:
a login field;
a search field;
a comment field;
a related videos portion;
a metadata display portion; and
a video display portion.

9. The method of claim 7, wherein the metadata that is displayed can be selected to view a corresponding video segment.

10. The method of claim 7, wherein the metadata that is enhanced is displayed according to corresponding relevance values, and wherein more relevant metadata is displayed more prominently than less relevant metadata.

11. Logic encoded in non-transitory media that includes instructions for execution and when executed by a processor, is operable to perform operations comprising:
detecting user interaction associated with a video file;
extracting interaction information that is based on the user interaction associated with the video file; and
enhancing the metadata based on the interaction information.

12. The logic of claim 11, wherein the enhancing comprises generating additional metadata associated with the video file.

13. The logic of claim 11, wherein the enhancing comprises determining relevance values associated with the metadata.

14. The logic of claim 13, wherein the determining of the relevance values comprises generating a first set of relevance values of the metadata for a first group of users, and generating a second set of relevance values of the metadata for a second group of users that are different from the first group of users.

15. The logic of claim 11, the operations further comprising:
refining a metadata model with the metadata that was enhanced in order to predict a video of interest for a particular user.

16. An apparatus, comprising:
a memory element to store data; and
a processor to execute instructions associated with the data, wherein the processor and the memory element cooperate such that the apparatus is configured to:
detect user interaction associated with a video file;
extract interaction information that is based on the user interaction associated with the video file; and
enhance the metadata based on the interaction information.

17. The apparatus of claim 16, wherein the enhancing comprises generating additional metadata associated with the video file.

18. The apparatus of claim 16, wherein the enhancing comprises determining relevance values associated with the metadata.

19. The apparatus of claim 18, wherein the determining of the relevance values comprises generating a first set of relevance values of the metadata for a first group of users, and generating a second set of relevance values of the metadata for a second group of users that are different from the first group of users.

20. The apparatus of claim 16, the apparatus being further configured to:
refine a metadata model with the metadata that was enhanced in order to predict a video of interest for a particular user.
